(19) United States
(12) Patent Application Publication
(10) Pub. No.: US 2022/0046897 A1
(43) Pub. Date: Feb. 17, 2022

(54) SYSTEM AND METHOD FOR CONTROLLING ANIMALS

(71) Applicant: STONELEIGH PASTORAL PTY LTD, Melbourne, VIC (AU)

(72) Inventors: Peter John MICHELL, Melbourne, Victoria (AU); Edouard Fernen PETER, Melbourne, Victoria (AU); Gusius Singh GUS, Melbourne, Victoria (AU); Wayne Allan BROWN, Melbourne, Victoria (AU)

(21) Appl. No.: 17/415,512

(22) PCT Filed: Dec. 18, 2019
(86) PCT No.: PCT/AU2019/000156

§ 371 Date: Jun. 17, 2021

(30) Foreign Application Priority Data
Dec. 18, 2018 (AU) 2018904821

(51) Int. Cl. A01K 15/00; G01S 19/01

(52) U.S. Cl. CPC A01K 15/00; G01S 19/01

(57) ABSTRACT

Disclosed are a method, system and apparatus for controlling the movement of animals, and in some aspects, the virtual herding or steering of animals over large areas of land. In some aspects, the animal is steered towards a desired region when the animal is out of the desired region. In some aspects, the animals is steered away from a steering region when the animal is within the steering region. In some aspects, the animal is steered towards a reference, which can be made to move along a path, thus leading the animal along the path from a starting point to a finish point. The method, system and apparatus disclosed reduce the need for fences or the use of personnel to manage the animals

### PRIORITY

The present application claims priority from Australian Provisional Patent Application No. 2018904821 filed on 18 Dec. 2018.

The entire contents of this priority application are hereby incorporated by reference.

### TECHNICAL FIELD

The present application relates to controlling the movement of one or more animals, or herding animals over an expanse of land.

### BACKGROUND

On large properties of land supporting one, two, or a heard of animals such as sheep, cows, buffalo and/or camels, it is often necessary to be able to control their movements in order to ensure that they avoid particular regions, and/or to move them from one area of the land to another area of the land, for example, for feeding or shearing. In other cases, a group of animals may need to be brought to an area for collection and loading onto vehicles for moving to another property. Such tracts of land can cover areas of hundreds of square kilometres or more.

On such expanses of land, fencing is often impractical, since the amount of space that may be required lo be fenced, as well as the cost and time of upkeep of such fencing, is great. Furthermore, the management and employment costs of employing people to move the animals from one location to another on the property can also be considerable

Accordingly, it would be useful to provide an alternative system and method to manage the movement of one or more animals over a large tract of land.

### SUMMARY

According to a first aspect, there is provided a method of controlling the movement of an animal, the method comprising: steering the animal towards a desired region if the animal's location is outside the desired region.

According to a second aspect, there is provided a method of controlling the movement of an animal, the method comprising: steering the animal towards a desired region if the animal's location is not in the desired region and the animal has a heading that is outside of an allowable heading range.

According to a third aspect, there is provided a method of controlling the movement of an animal, the method comprising: steering the animal out of a steering region if the animal's location is inside the steering region.

According to a fourth aspect, there is provided a method of controlling the movement of an animal from a start location to a destination location, the method comprising: if the animal's position is within a steering region, then steering the animal out of the steering region towards a desired region defined by a shunt line having the desired region on a side of the shunt line incorporating the destination location and the steering region on the other side of the shunt line.

According to a fifth aspect, there is provided a method of defining a path between a start location to a destination location, the method comprising: defining one or more waypoints between the start location and the destination location.

According to a sixth aspect, there is provided a method of determining whether to apply a stimulus to an animal, the method comprising determining the animal's location; comparing the animal's determined location with one or more system settings; and determining to apply the stimulus to the animal if the animal's location is outside of one or more of the one or more system settings.

### BRIEF DESCRIPTION OF DRAWINGS

Various aspects and embodiments will be described below with reference to the accompanying drawings in which:

FIG. 1A—shows an example of a steering method according to an aspect relating to a desired region;

FIG. 1B—shows another embodiment of the aspect of FIG. 1A;

FIG. 1C—shows another embodiment of the aspect of FIG. 1A;

FIG. 1D—shows another embodiment of the aspect of FIG. 1A;

FIG. 1E—shows another embodiment of the aspect of FIG. 1A;

FIG. 2A shows an example of a steering method according to an aspect relating to a reference;

FIG. 2B—shows another embodiment of the aspect of FIG. 2A;

FIG. 3A—shows an example of a steering method according to another aspect relating to a reference;

FIG. 3B—shows another embodiment of the aspect of FIG. 3A;

FIG. 3C—shows another embodiment of the aspect of FIG. 3A;

FIG. 3D—shows another embodiment of the aspect of FIG. 3A;

FIG. 4—shows an embodiment of the method of FIGS. 1A to 1E using an allowable heading range;

FIG. 5—shows an embodiment of the method of FIGS. 2A to 3D using an allowable heading range;

FIG. 6—shows the movement of a desired region along a path;

FIG. 7—shows the movement of a desired region along a multi-segment path and using the allowable heading range;

FIG. 8—shows an aspect of the steering region;

FIG. 9—shows the use of the steering region of FIG. 8 with a desired region;

FIG. 10—shows the use of a shunt line;

FIG. 11—shows the movement of the shunt line of FIG. 10 along a path;

FIG. 12—shows another aspect of the shunt line moving along the path;

FIG. 13—shows a path with a waypoint defined thereon;

FIG. 14—shows a path with a plurality of waypoints defined with reference to geographical features;

FIG. 15—shows the orientation of the shunt line along the path according to one aspect;

FIG. 16—shows the orientation of the shunt line along a path according to another aspect;

FIG. 17—shows the use of the shunt line as a series of splines;

FIG. 18—shows the spline shunt line moving along a path;

FIG. 19—shows the orientation of the spline shunt line along the path;

FIG. 20—shows an embodiment of a stimulating device;

FIG. 21—shows an embodiment of a steering environment for multiple devices;

FIG. 22A—shows an embodiment of a “communications out” arrangement;

FIG. 22B—shows an embodiment of a “communications in” arrangement;

FIG. 23—shows an embodiment of a stimulating device according to another aspect;

FIG. 24—shows an area of land with a path overlain thereon;

FIG. 25—shows an embodiment of a user interface with system settings according to one aspect;

FIG. 26—shows an embodiment of a user interface with system settings according to another aspect;

FIG. 27—shows an embodiment of a user interface with system settings according to another aspect; and

FIG. 28—shows an example of a flowchart of a method of determining whether to apply a stimulus to an animal according to an aspect.

### DESCRIPTION OF EMBODIMENTS

In a broad aspect, there is provided a method of steering an animal towards a desired region if the animal's location is outside the desired region.

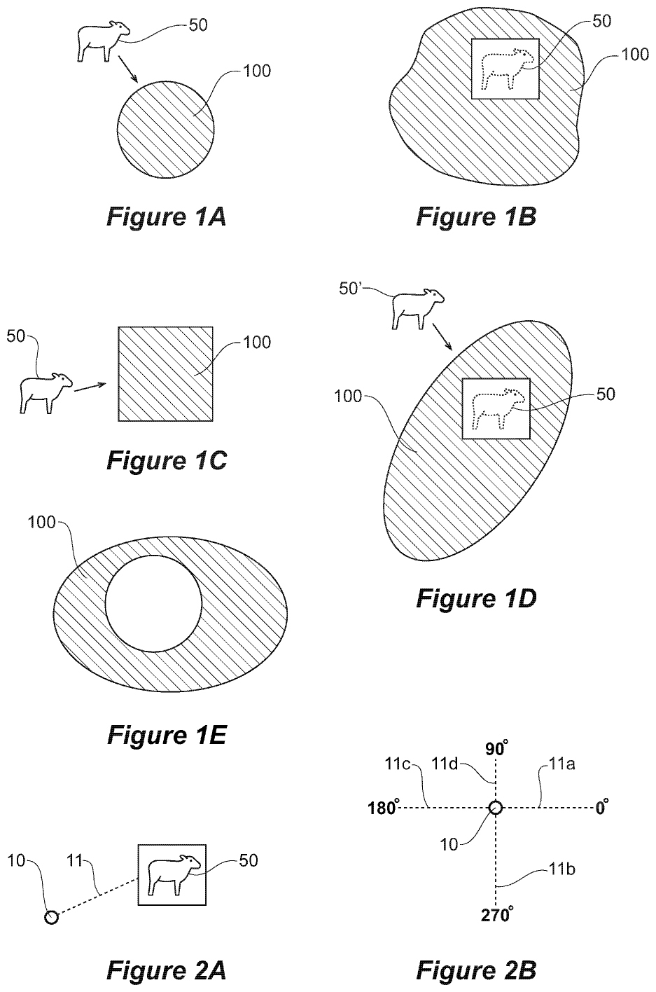

FIGS. 1A to 1D show various examples of this aspect. FIG. 1A shows a desired region 100 (in this example defined as an area within a circle). A desired region is a region in which it is desired that the animal should be. In the example of FIG. 1A, an animal 50 is located outside of the desired region 100. According to this aspect, the animal 50 is steered towards the desired region so that over time, its location is within the desired region. It should be noted that an animal that is in the desired region will not be prevented from leaving the desired region, but in some aspects, will be coaxed or steered back, once it has left.

It will be understood that the terms “steer” or “steering” in the context of this application, means to cause the animal to move in a certain direction by application of one or more stimuli to the animal by a stimulating device attached to the animal. In some embodiments, the stimulus is generated in accordance with a stimulus command signal received by the stimulus device. in some embodiments, the stimulus is generated by the device in accordance with a determination made by the device itself, and requires no external instruction. In some embodiments, the stimulus is an electrical stimulus. In some embodiments, the stimulus is a vibration stimulus. In some embodiments, the stimulation is a haptic stimulus. In some embodiments, the stimulus is a combination of two or more types of stimuli. The steering of an animal will be described in more detail below.

FIG. 1B shows another example of a desired region 100, in this case, defined as the region within a particular function providing an irregular boundary. In this example, the animal 50 is located within the desired region. In embodiments of this aspect, since the location of the animal is within the desired region 100, there is no need to cause the animal to change location, and no steering of the animal is required. The animal 50 is therefore allowed to roam freely anywhere within the desired region 100. If over time, the animal 50 strays outside of the desired region 100, or the desired region 100 moves such that the animal 50 is no longer within the desired region 100, then, in some aspects, the animal 50 is steered towards the desired region 100 so that its location is once more within the desired region 100.

FIG. 1C shows another embodiment in which the desired region 100 is defined as the region within a square. In this example, the animal 50 is outside of the desired region 100 and so is steered towards the desired region 100.

FIG. 1D shows another example of a desired region 100, in this example defined as the region within an ellipse. In this example two animals 50, 50′ are shown, with one animal 50 within the desired region 100 and the other animal 50′ outside of the desired region 100. In this case, the animal 50′ outside of the desired region 100 will be steered towards the desired region 100, while the animal 50, inside the desired region 100, will have no steering applied, and it will be allowed to wander freely while it remains within the desired region 100.

In some further embodiments, a desired region 100 may have a region within it from which animals may, in some embodiments or circumstances, be steered towards the surrounding desired region 100, as shown in FIG. 1E.

According to another aspect, as shown in FIGS. 2A and 2B, there is provided a method of steering an animal with respect to a reference 10. In its simplest embodiment, this provides for a reference distance 11 of a given length, providing for steering the animal 50 if the animal's location is beyond the reference distance 11. In some embodiments, the reference distance 11 is adjustable, to allow adjustment of the desired region 100. In some embodiments, the reference distance 11 is adjustable according to an angular position with respect to the reference 10. For example, as shown in FIG. 2B, for all reference distances 11 at or between 180 deg and 360 deg, (namely 11a, 11b, 11c) the reference distance will be greater than any reference distance (11a) between 0 deg and 180 deg. This may be done for example, to steer an animal away from a region that is not to be grazed on. Various embodiments of steering will be described in more detail below.

In some aspects, the reference 10 is virtual, that is, in some embodiments, is represented by a series of coordinates overlaid on an actual expanse of land over which the animal 50 is to be steered. Such coordinates can he in any suitable form including Global Positioning System (GPS) coordinates, Cartesian coordinates, polar coordinates, latitude and longitude coordinates or a customised coordinate system used for the particular expanse of land.

In other aspects, the reference 10 may be provided by an actual object placed on the land, and may be used to directly reference steering control instructions therefrom. In some examples of this aspect, the reference 10 is a transponder, transceiver or transmitter. In some embodiments, the reference 10 is, or is on, a mobile platform such as a remote-control vehicle. In other embodiments, the reference 10 is airborne, such as a drone.

In further embodiments, the reference 10 is provided by a device mounted to one of the animals in the herd, and in some particular examples, to the animal that is identified as the alpha or lead animal in the group. in many herds, there is one animal which leads the group, and the other animals follow that animal. If that animal is guided through a path according to aspects described herein, the other animals will naturally follow that animal, thus potentially reducing the load on the system of otherwise steering each individual animal using their individual steering or stimulus devices.

While the term “reference” is used, it will be understood that the reference need not be a point, and may extend over a certain space, including between centimetres and metres.

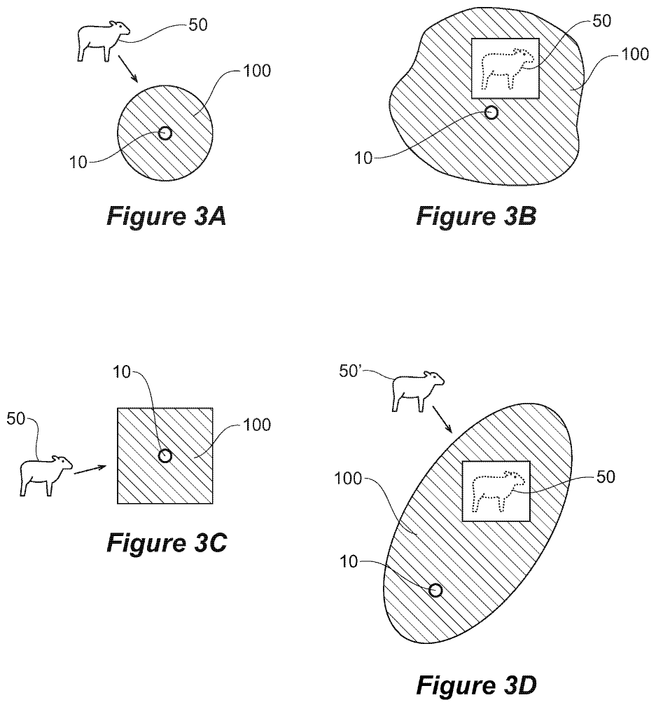

In some aspects, the desired region 100 is defined with respect to the reference 10. FIGS. 3A to 3D show different embodiments of this aspect. FIG. 3A shows a desired region 100 defined as the area within a circle, with the reference 10 at its centre. FIG. 3B shows the desired region 100 defined as the region within an irregular function defined with respect to reference 10. Such functions may be selected so as to accommodate characteristics of the land, such as features of geography or topology, or even type of grass in the area, to keep the animals away from dangerous or otherwise undesirable regions, such as steep hills, forests, or areas where grazing is undesirable. In some embodiments, the function defining the region may be generated using polar coordinates with a reference distance varying as the angle about the reference 10 varies.

FIG. 3C shows the desired region 100 defined as the region within a square with reference 10 located at its centre. FIG. 3D shows the desired region 100 defined as the region within an ellipse with respect to reference 10, located at one of its foci.

As with the aspects described with reference to FIGS. 1A to 1D, the animals 50 shown in the respective figures will be steered (or not) according to their location with respect to the desired region 100. In these aspects in which the desired regions are defined with respect to a reference 10, in some embodiments, the animals are steered with respect to the reference 10, and thus inherently, with respect to the desired region 100. Further examples of these aspects will be described in more detail below.

According to another aspect, there is provided a method of controlling the movement of an animal with respect to a reference, the method comprising steering the animal towards a desired region if the animal's location is not in the desired region and the animal has a heading that is outside of an allowable heading range.

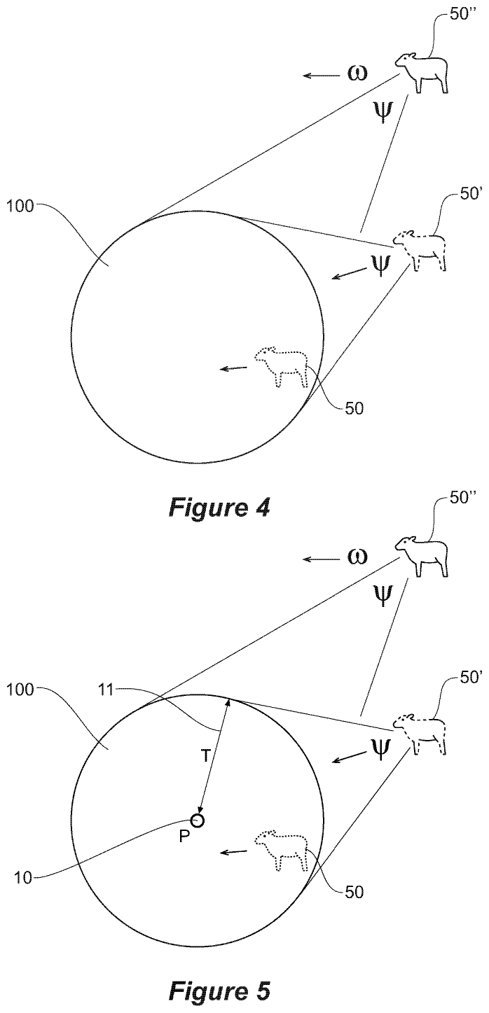

FIG. 4 shows an embodiment of this aspect, with desired region 100 defined as a region within a circle in this example. Animal 50 is located within the desired region and so no steering is required for this animal. Animal 50′ is however, located outside of the desired region. However, in contrast to the previous aspect, even though animal 50′ is located outside of the desired region 100, it has a heading that is within an allowable heading range Ψ. This aspect provides a “looser” steering regime in which animals that are outside of the desired region but not heading too far away (within a pre-defined range), are not steered and are allowed to continue to roam freely, until they adopt a heading that is outside of the allowable heading range. In some embodiments, the allowable heading range is defined as a heading range that at least partially encompasses the desired region 100. In tighter steering protocols, the allowable heading range is defined so as to completely encompass the desired region 100, such as shown in FIG. 4.

Animal 50″ is also located outside of the desired region 100, but it has a heading (i) that will take it outside of its allowable heading range and away from the desired region 100. In this case, the animal 50″ will be steered towards the desired region until its heading is within its allowable heading range, at which time, steering may be stopped until it deviates again from its allowable heading range. In these aspects, in some embodiments, it will be appreciated that once the animal 50″ has a heading that has returned to being within its allowable heading range, no steering or stimulation need be applied, even if its position is not within the desirable region 100.

It will be appreciated that being able to provide a less rigid steering protocol by not steering animals outside of the desired region, allows less power to be consumed by the stimulating device. When the stimulating device is required to be carried by the animal, it has weight and size limitations as well as a limited battery life, and so the ability to reduce power expenditure is useful.

Of course, in instances where a tighter steering protocol is required, for example when the animals are required to be herded to an area in a shorter time, or where there are regions along the herding path that are dangerous for the animals to venture into, then a method according to the previous aspect may be employed, in which an animal is steered towards the desired region 100 whenever it is outside of the desired region 100 as it moves along the defined path.

FIG. 5 shows an embodiment of the aspect described above with reference to FIG. 4, in which the desired region 100 is defined with respect to a reference 10. In this example the desired region 100 is defined as the region within a circle defined by reference distance 11 of “T” metres (for example 50 metres) with reference 10 located at the centre of the circle.

In such embodiments, the allowable heading range Ali may be defined such that it encompasses the reference 10.

It will be appreciated that an animal's heading may be determined by any suitable means, including simply determining its location at one point in time, determining its location at a subsequent point in time (e.g. 30 seconds later, 1 minute later, 5 minutes later, 10 minutes later or more), and determining its heading from those measurements.

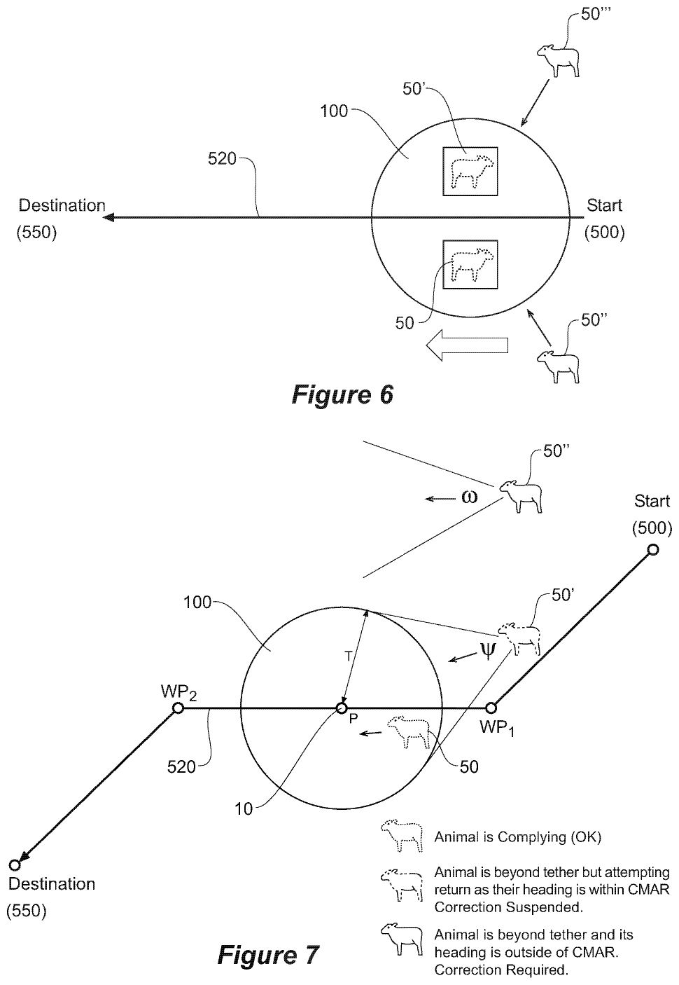

According to another aspect, there is provided a method of controlling the movement of an animal from a start location to a destination location. As shown in FIG. 6, in this aspect, a path 520 is defined between the start location 500 and the destination location 550. The desired region 100, is caused to move along the path 520, essentially “dragging” the animals 50, 50′, 50″ and 50′″ with it along the path towards the destination location 550. As seen in FIG. 6, the animals 50, 50′ are within the desired region 100 and so no steering is required of those animals. Animals 50″ and 50′″ are outside of the desired region 100 and so according to this aspect, they are steered towards the desired region 100.

It will be appreciated that it is possible that one or more of the animals 50″, 50′″ may never enter the desired region as it moves along path 520, but they will continue to be steered to follow the desired region 100 until they also reach the destination location 550 at which time they may enter desired region 100. Similarly, it is possible that as the desired region 100 moves along the path 520 towards the destination location 550, that one or more of the animals 50, 50′ inside the desired region 100 will be overtaken by the moving desired region (for example if they remain stationary for a time, or are moving in the opposite direction) and will come out of the desired region 100 as it moves along, at which point they too will be steered back towards the desired region.

FIG. 7 shows this aspect in relation to the aspect described with reference to FIG. 5, in which an animal 50′ may be outside of the desired region 100 but not steered, since its heading is within the allowable heading range, and is moving towards, or at least not straying from, the desired region 100. Again, in this arrangement shown, animal 50″ will be steered towards desired region 100 since its heading is outside of the allowable heading range as previously described. This process will continue while the desired region 100 has travelled along the path 520, so as to bring the animals with it to destination location 550, and will continue even when it has reached the destination location 550 to ensure that the animals stay at that location, or until otherwise penned or contained.

It will also be noted that in this embodiment, the path 520 is divided into segments, with two waypoints WP₁ and WP₂ along the path. The use of waypoints will be described in more detail below.

According to another aspect, there is provided a method of controlling the movement of an animal, the method comprising steering the animal out of a steering region if the animal's location is inside the steering region.

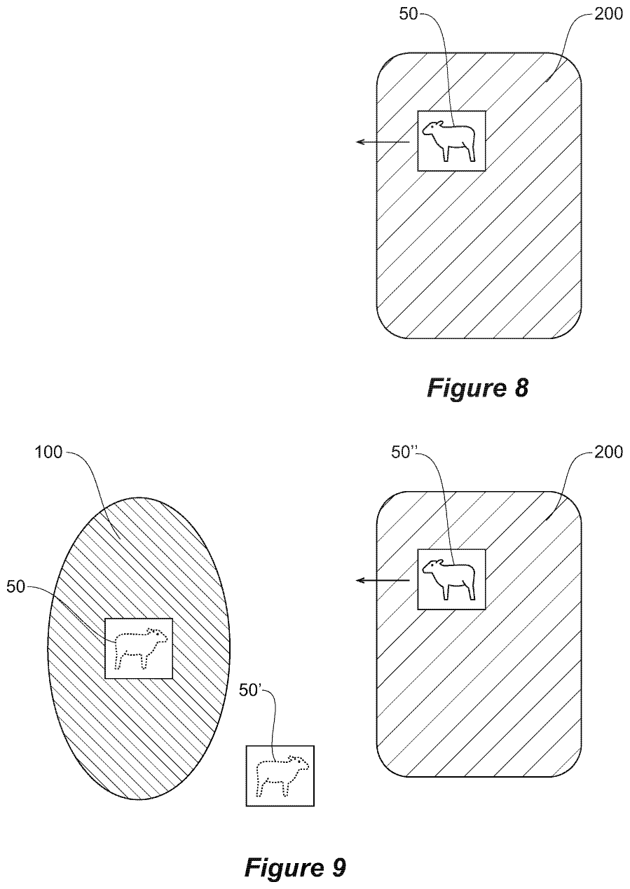

FIG. 8 shows an embodiment according to this aspect, in which a steering region 200 is defined. Any animal 50 within this region will he steered out of the steering region 200.

In some embodiments of this aspect, a desired region 100 is also defined. FIG. 9 shows the steering region 200 of FIG. 8, and a desired region 100. There is an animal 50 inside the desired region 100. According to this aspect no steering is applied to the animal 50. Similarly, although animal 50′ is outside of the desired region, it is not inside the steering region, and so no steering is applied to animal 50′ in this embodiment. Animal 50″ is in the steering region 200, and so, according to this aspect, is steered out of the steering region 200.

While the steering region 200 and the desired region 100 in FIG. 9 are not necessarily defined with respect to a reference, it will be appreciated that in some embodiments the steering region 200 and/or the desired region 100 are defined with respect to a reference as previously described. It will also be appreciated that the steering region 200 can be caused to move along a defined path towards a destination location 550 as previously described, so as to “push” the animals ahead of it towards the destination location 550.

According to another aspect, there is provided a method of steering an animal from a start location to a destination location, the method comprising: steering the animal out of a steering region towards a desired region if the animal's position is within the steering region. In one aspect, a shunt line is defined, having the desired region on a side of the shunt line incorporating the destination location and the steering region on the other side of the shunt line.

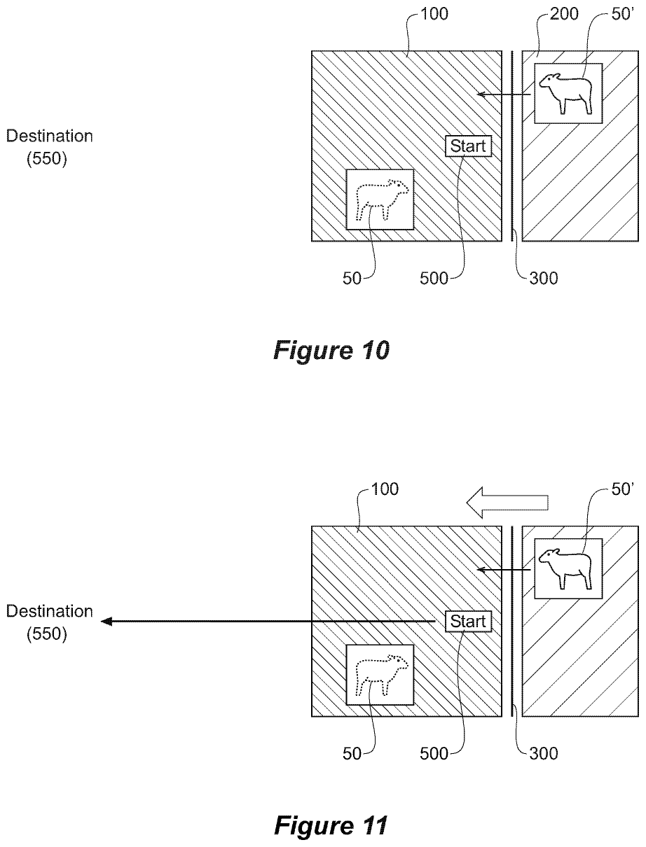

FIG. 10 shows an embodiment according to this aspect. Seen in this view is shunt line 300 with steering region 200 behind and desired region 100 in front. Start location 500 is also seen, within the desired region 100. Once established, this arrangement will cause any animal 50′ that is “behind” the shunt line 300 to be steered outside of the steering region 200 towards the desired region 100. Any animals 50 that are located in front of the shunt line (in the desired region or even any that are already between the desired region 100 and the destination location) will not be steered.

FIG. 11 shows the arrangement of FIG. 10 when the shunt line 300 is caused to start moving towards the destination location 550, in the direction of the arrow.

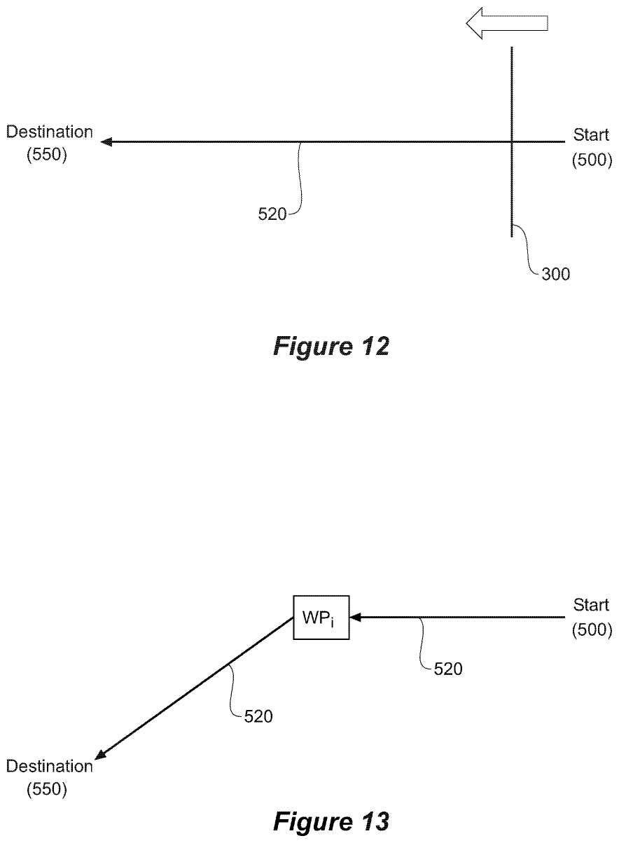

FIG. 12 shows an embodiment in which the shunt line 300 is caused to move along defined path 520 from start location 500 to destination location 550 as shown by the arrow.

According to another aspect, in some embodiments, the path 520 may be divided into segments, with one or more waypoints WP₁ defined thereon as shown in FIG. 13. This allows a path 520 to be defined that can provide a non-linear route to steer the animals around obstacles or other features that may be present in the path between the start location 500 and the destination location 550.

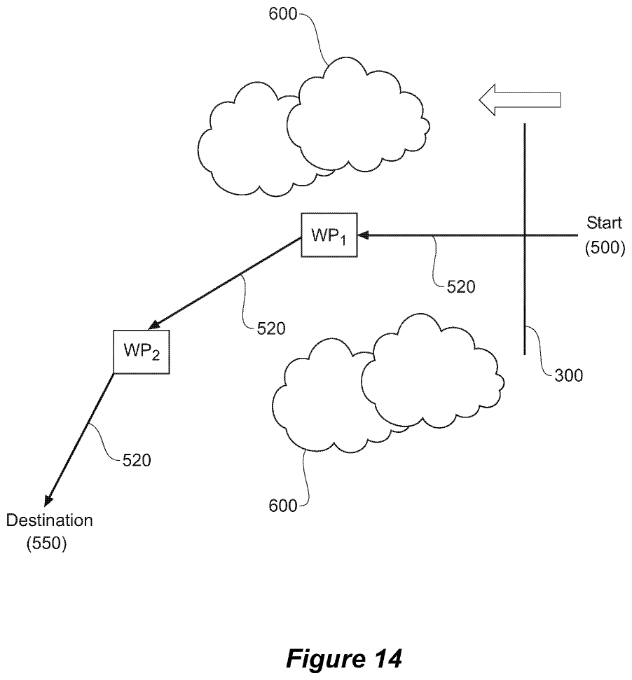

FIG. 14 shows an application of this aspect, the path 520 having two waypoints WP₁ and WP₂. In this example, a path 520 must be defined to lead the animals from start location 500 to destination location 550, however, because of the presence of a characteristic 600 of the land through the path, specifically trees in this example, the animals cannot reach the destination location 550 in a straight line from the start location 500 and must be guided along a “curved” path through the trees.

In some embodiments, the shunt line 300 is orientated so that it is substantially perpendicular to the path line 520 joining the shunt line to the next waypoint WPi.

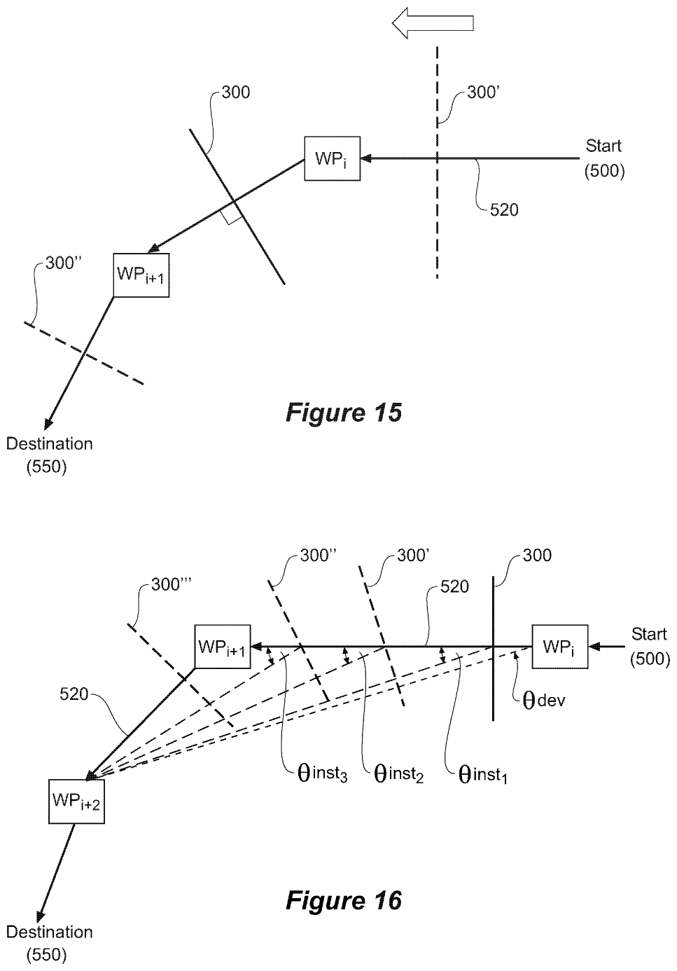

FIG. 15 shows a path 520 between start location 500 and destination location 550, with two waypoints WP₁ and WP₂ defined within the path 520. According to this aspect, the shunt line 300 will be orientated so as to be substantially perpendicular to the path 520 along which it is travelling. As can he seen from FIG. 15, shunt line 300 between WP₁ and WP₂ is shown to be substantially perpendicular to that portion of the path 520 between WP₁ and WP₂. Before that, when shunt line 300 was on the path 520 between the start location 500 and the first waypoint WP₁, (indicated as dotted shunt line 300′), the shunt line 300 was substantially perpendicular to that section of the path. Similarly, in a future time, when shunt line 300 reaches the section of path 520 between waypoints WP₂ and WP₃ (shown as dotted shunt line 300″), it will be turned again so that its orientation is substantially perpendicular to that section of the path.

In some embodiments, the orientation will flip as the shunt line begins to move onto the relevant segment just after the waypoint.

The benefit of changing the orientation of the shunt line as it moves along the “curved” path 520 is that it assists to more sharply focus the direction of herding of the animals along the path 520 towards the destination point 550 and to bring those animals above the path 520 (as seen in the figures), around and towards the destination 550.

In other embodiments, a more “smooth” orientation transition can be provided so that the jump from one perpendicular orientation to the next is not as sudden when the shunt line 300 begins its movement along the next section of path 520. In such embodiments, the orientation of the shunt line 300 is turned as the shunt line moves along the path 520, and in some embodiments, is dependent upon the proximity of the shunt line 300 to a future point such as the destination or a future waypoint Wᵢ.

FIG. 16 shows an embodiment of this aspect, in which a maximum deviation angle θ_{dev} is determined. In some embodiments, θ_{dev} is defined by the acute angle at the waypoint WPᵢ between the line joining the waypoint WPᵢ and a waypoint WPᵢ₊₁ and the line joining waypoint WPᵢ and a waypoint WPᵢ₊₂.

An instantaneous angle θᵢₙₛₜ is defined by the acute angle at the shunt line between the line joining the waypoint WPᵢ and a waypoint WPᵢ₊₁, and the line joining waypoint WPᵢ and a waypoint WPᵢ₊₂.

If the instantaneous angle θᵢₙₛₜ is greater than the maximum deviation angle θ_{dev} then the shunt line is rotated towards a point ahead, such as the waypoint WPᵢ₊₂ as shown in FIG. 16.

In FIG. 16, the maximum deviation angle θ_{dev} is shown as the acute angle at the first waypoint WPᵢ. As the shunt line 300 moves towards waypoint WPᵢ₊₁, it has an instantaneous angle θᵢₙₛₜ as shown in FIG. 16. Since this angle θᵢₙₛₜ₁ is only slightly more than the maximum deviation angle θ_{dev} set for that path segment, very little turning of the shunt line is required to bring its angle θᵢₙₛₜ₁ to being less than the maximum deviation angle θ_{dev}.

As the shunt line 300 continues to move along path 520 (to become shunt line 300′), its instantaneous angle θᵢₙₛₜ, specifically θᵢₙₛₜ₂ becomes even greater than maximum deviation angle θ_{dev}, and so its orientation is turned more towards WPᵢ₊₁ such that its instantaneous angle θᵢₙₛₜ₂ is reduced to being less than the maximum deviation angle θ_{dev}. In this way, the shunt line 300 remains “pointed towards” a future point, thus making the herding of the animals in front of it a more gradual turn for them over the path 520 and thus more likely to keep them on track.

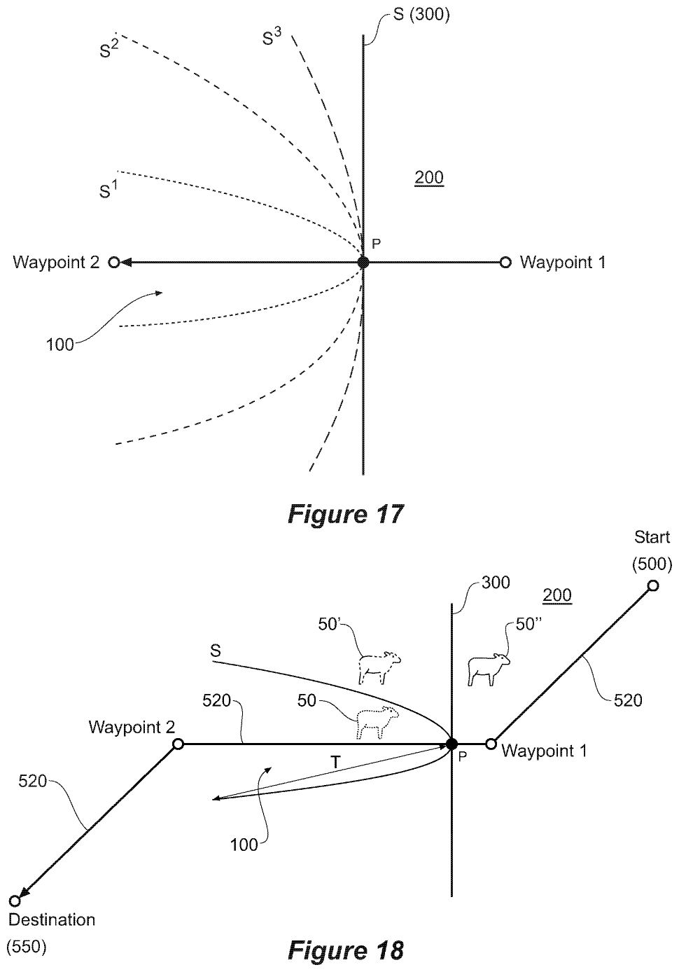

In some embodiments, a more focussed or “tighter” herding or steering protocol can be implemented by curving the shunt line 300 as a spline locus. FIG. 17 shows the shunt line 300 (S) as a straight line, on the path 520 between waypoints WP₁ and WP₂. The shunt line 300 can be curved inwards to form a “parabola” locus. The extent of inward curving, and therefore the “width” of the parabola, is controlled by setting a locus angle of displacement relative to the asymptote (or original shunt line 300) as will be understood by the person skilled in the art.

This effectively produces a desired region 100 within the locus, towards which animals are steered. The ability to vary the “narrowness” of the spline locus parabola provides for the ability to change the strictness of the herding depending on waypoints Wᵢ through which the curve is passing, which can be established according to one or more characteristics of the land at which the waypoint is set. For example, referring back to FIG. 14, at the start location 500, the shunt line can be a vertical line as shown in FIG. 14. As it moves towards the area of land along the path 520 which has trees 600 on either side, an additional waypoint WP₀ can be inserted into the path which need not necessarily change the direction of the path, but could be a signal for the shunt line to be curved and narrowed (such as to be of the form of spline S¹ in FIG. 17), so as to more tightly herd the animals through the narrower path bounded by the trees 600. As the shunt line passes through the trees and hits waypoint WP₂, this can act as a signal to open the shunt line again to a wider configuration, such as S³ in FIG. 17.

FIG. 18 shows another embodiment in which the spline locus of FIG. 17 is caused to move along path 520 between start location 500 and destination location 550, passing through waypoints WP₁ and WP₂. In these embodiments, the inside of the spline locus can be defined as a desired region 100, in which any animals 50 within that region are not steered. In some embodiments, animals 50′ that are outside of the desired region 100 but not in the steering region 200 behind the shunt line 300 (which in some embodiments can be provided by the asymptote of the spline locus parabola at the vertex), can either also not be steered, or in other embodiments, may be steered towards the desired region 100 as in the embodiments previously described with reference to FIGS. 1A to 3D, or, in other embodiments still, may be not steered if they have a heading within an allowable heading range Ψ, but may be steered if their heading is outside of the allowable heading range Ψ, as previously described with reference to FIGS. 4 and 5. Any animals 50″ within steering region 200 behind the shunt line will be steered towards the allowable region or the area in front of the shunt line 300.

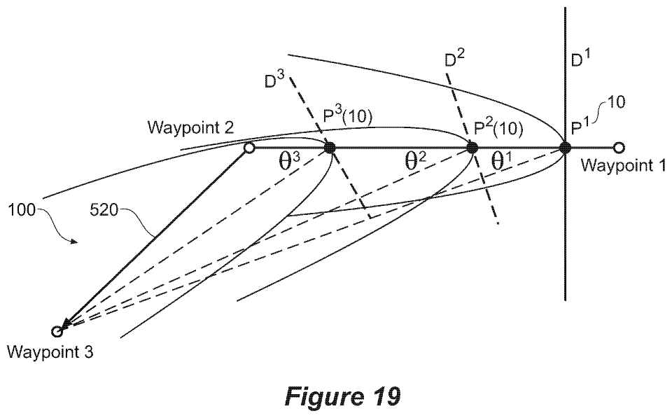

In some embodiments, the axis of the parabola may be orientated to be in line with the path 520 between each waypoint on which the parabola is travelling (and thus the shunt line kept substantially perpendicular to the path 520, as detailed with reference to FIG. 15) or the tighter herding protocol of dynamically orientating the desired region 100 as described with reference to FIG. 16 may be implemented, as shown in FIG. 19.

In some embodiments, the shunt line 300 and the desired region 100 are defined with reference to reference 10, as shown in FIGS. 18 and 19, and are moved along the path 520 by causing the reference 10 to move along the line 520.

The various aspects described above may be implemented in various ways. In some aspects, the stimulating device will effectively be a “dumb” device, which generates and applies stimuli to the animal upon receipt of a stimulus command signal received remotely. In these aspects, any sensing and processing is done by a remote device, which generates the stimulus command signal for transmission to the appropriate stimulus device in accordance with the processing.

In these aspects, the stimulus command signal may be transmitted directly to the stimulus device on the animal, or may be transmitted to one or more ground-based transceivers or transponders located throughout the property, which in turn relay the stimulus command signal to the appropriate stimulus device.

In some other aspects, the stimulus device performs all necessary sensing and processing and applies the stimulus in accordance with the results of its own processing.

In some other aspects, some of the processing is conducted remotely, and some by the stimulus device.

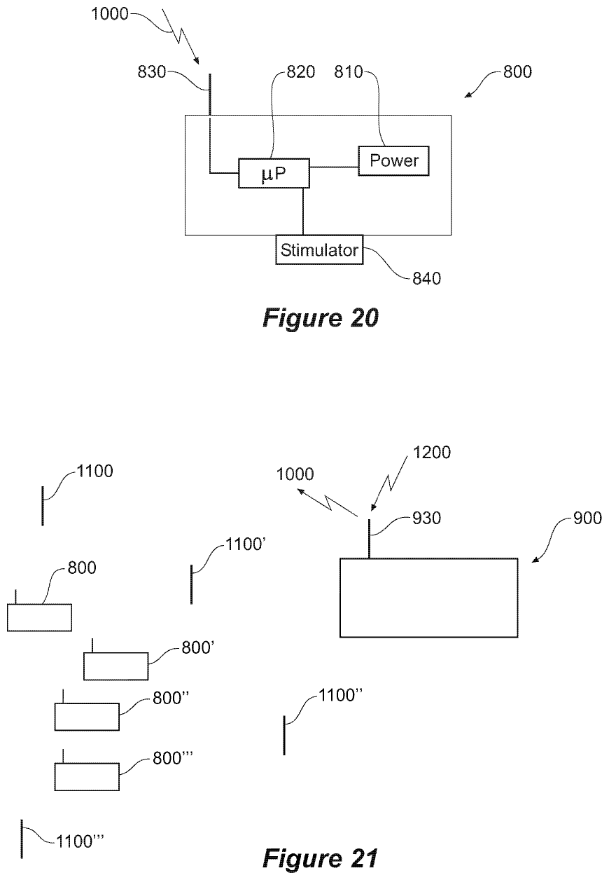

In a broad aspect of the “dumb” stimulus device, there is provided a stimulus device 800 as shown in FIG. 20. In some embodiments, stimulus device 800 has a microprocessor 820, a power source 810, an antenna 830 and a stimulator 840.

In some embodiments, the power source 810 is provided by a battery. In some embodiments, the power source 820 is provided by a solar panel. In some embodiments, the power source 820 is provided by a battery and solar panel which charges the battery over time.

In some embodiments, the stimulator 840 is an electric stimulator to generate an electrical stimulus for application to the animal. In some embodiments, the stimulator 840 is a vibratory stimulator which generates a vibration for application to the animal. In some embodiments, the stimulator is a haptic stimulator which generates a haptic signal for application to the animal. In some embodiments, stimulator 840 provides two or more types of stimulus such as vibratory and electrical. In some embodiments, there are two or more stimulators provided, including 1, 2, 3, 4, 5, 6, 7, 8, 9 and 10 or more.

In some embodiments, devices 800 of the type described with reference to FIG. 20 are used in an environment as shown in FIG. 21. In this environment, one or more stimulus devices 800 are provided, in use, each connected to a respective animal, in a way that any stimulus generated by the device 800 will be perceived by that animal. Also provided is a processing device 900 which can be a remote computer terminal, on the actual tract of land, or even more remote in a building within communications range. In use, the processing device 900 receives location data 1200 relating to the location of a particular stimulus device 800 (and thus of the animal to which it is connected), and generates a stimulus command signal 1000 resulting from the processing of the location data in accordance with one or more of the methods described previously. This stimulus command signal 1000 is transmitted by the processing device to the relevant stimulus device 800. In some embodiments, one or more transceiver/transponders 1100 are located about the property, so as to be able to receive the stimulus command signal 1000 from the processing device and transmit it in the same, or a different form, to the relevant stimulus device.

In other embodiments, the stimulus command signal is transmitted directly to the relevant stimulus device through any convenient network, including a telecommunications network.

The stimulus command signal provides the relevant stimulus device 800 with the instruction to generate an appropriate stimulus to steer the animal according to one or more of the methods described above. In a broad aspect then, there is provided a device for applying a stimulus to an animal in accordance with one or more of the methods described herein.

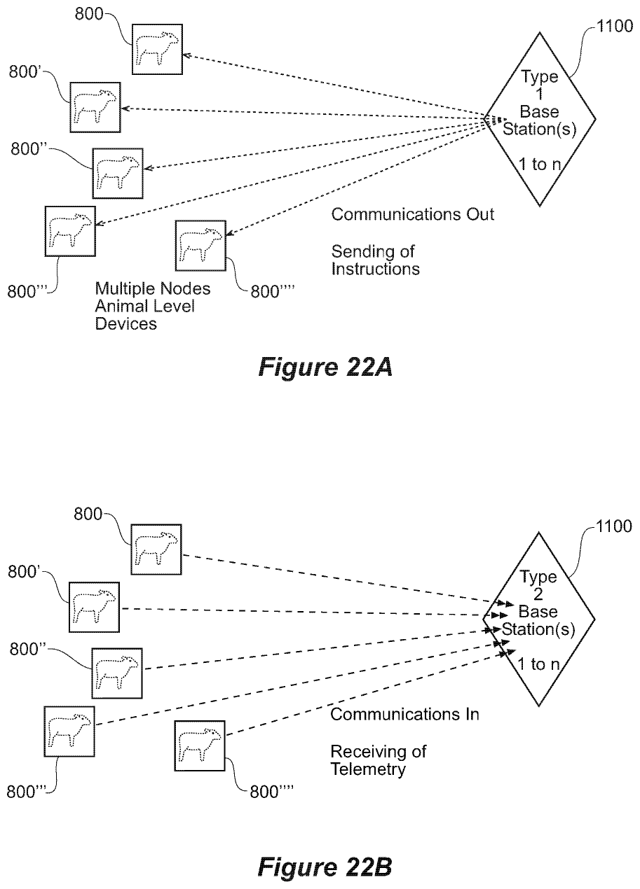

FIGS. 22A and 22B show an example of a suitable communications set up for the transactions described above. FIG. 22A shows an arrangement for transmitting data from the system in the form of one or more transmitting stations 1100 to one or more of the devices 800 . . . 800n. FIG. 22B shows an arrangement for receiving data from one or more of the devices 800 . . . 800n to one or more receiving station 1100.

It will be appreciated that any suitable communications systems and protocols can be used. An example of such a system is the Long Range (LoRa) system (LoRaWAN). This is a wireless data communications technology, enabling long range (e.g. 10 km or more) with low power consumption. Details of this system will be well understood by the person skilled in the art, who will be able to set up an appropriate network in a given area to provide communications over the long distances on a rural property.

Any device 800 that is able to receive a stimulus command signal and convert this to a stimulus for application to an animal wearing the device will be suitable as will be understood by the person skilled in the art.

According to other aspects, the stimulus device 800 is fully integrated and performs all of the necessary data reception, processing, sensing and generation of the stimulus as required.

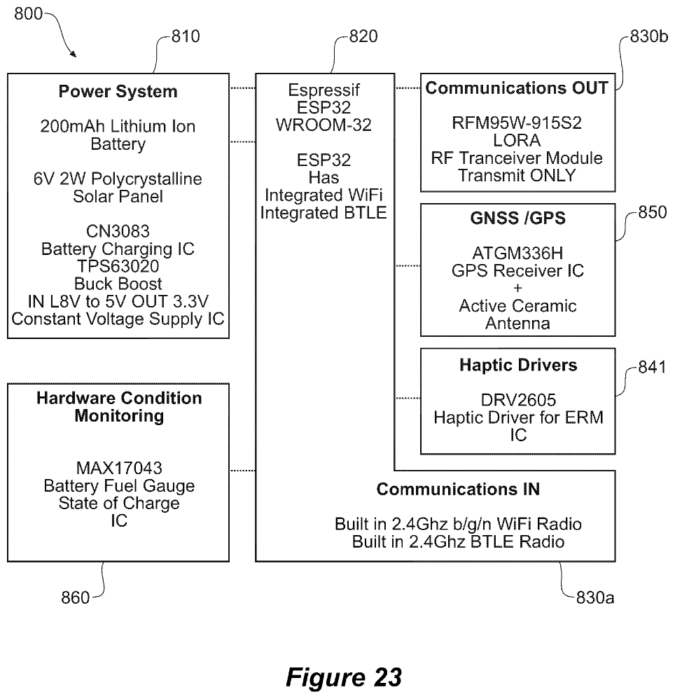

FIG. 23 shows a system block diagram according to some embodiments, of a suitable architecture for a device 800 of this type. There shown is SoC microprocessor IC 820 for loading, the relevant instructions to define the path 820, various waypoints and general system parameters (as will be described in more detail below), as well as the computational algorithms for comparing the animal's position with respect to the set path and determining whether and what stimulus to generate if necessary, as well as controlling all the other subsystems on the chip. An example of a suitable chip for this use is the Espressif ESP8266 or ESP32 series provided by Espressif Systems (Shanghai) Co. Ltd., however, any other chip that is capable of performing these functions may be used.

Power source 810 may be provided by batteries, solar panels or a combination of both as previously described, and may also include circuitry to provide a constant voltage supply where the voltage generated by the system can vary.

Communications blocks 830a, 830b for providing receiving and transmitting functions are also provided, and again, can be of any suitable form depending on the communications system used, including for use with the LoRa system. An example of a device suitable for the Communications Out block 830b is the RFM95W-915S2 device for the LoRa protocol, provided by manufacturer RF Solutions. In some embodiments, the Communications In block 830a may be provided by the inbuilt communications functionality of the Espressif chip described above, or a separate device may he provided in some embodiments.

In some embodiments, even though all the processing and stimulation is controlled by the device 800, it still receives data from an external source to allow new paths, waypoints and system parameters to be uploaded, as well as any software updates.

Global Navigation Satellite System (GNSS) block 850, provides positional data of the position of the animal wearing the device 800, and provides this to the microprocessor 820 for use in its calculations. The GNSS system may be any suitable satellite positioning system that provides autonomous geo-spatial positioning. This includes GPS, GLONASS, Galileo and Beidou. In some embodiments, other non-satellite positioning systems such as use of signals in a cellular network may also be used where appropriate.

In some embodiments, Hardware Condition Monitoring block 860 is provided to provide data relating to the status of the hardware, such as temperature, insulation, battery charge state to the microprocessor 820. This data may be used by the microprocessor 820 and/or be transmitted to a system user via communications out block 830b. An example of a chip that could provide this monitoring function is the MAX17043 Battery Fuel Gauge State of Charge IC provided by Maxim Integrated Products Inc. It will be appreciated however, that any other suitable device may be used.

Once all the input data is processed by the microprocessor 820, and a determination is made to apply a stimulus to the animal, control signals are sent to the haptic driver 841 for driving a haptic stimulator 840. An example of a suitable device for the haptic driver is a DRV2605 IC provided by Texas Instruments Incorporated.

In other embodiments, haptic driver 841 may be replaced by other suitable drivers if other stimulation forms are used, such as simple vibratory or electrical stimulus.

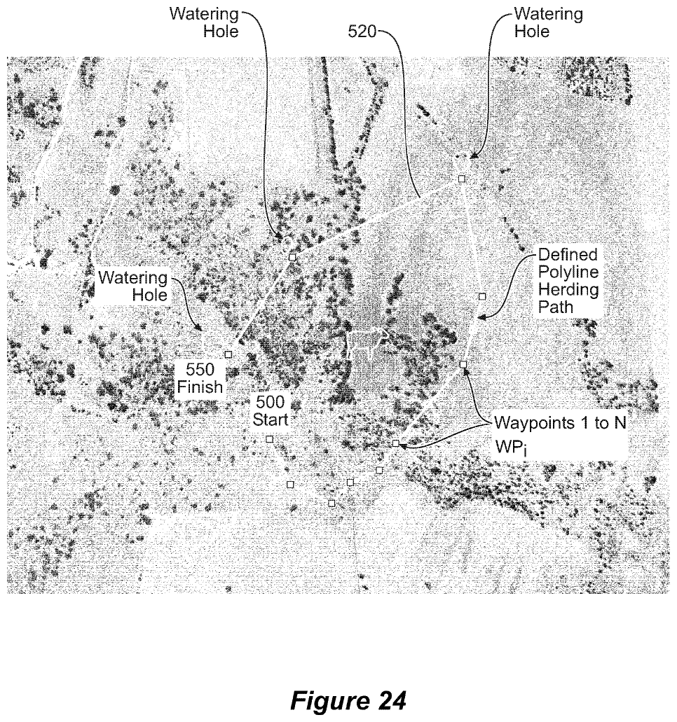

FIG. 24 shows an example of an area of land over which a virtual path 520 is overlain. In this example, a path 520 is defined between a start location 500 and a destination location 550, with a plurality of way points WPᵢ defined thereon. In this example, the path causes the animals to pass by a number of geographical features such as the various watering holes indicated in FIG. 24. In some embodiments, the waypoints may be set to make use of natural characteristics or features of the land that may act as attractants for the animals, such as watering holes.

In some embodiments, a waypoint is defined by a GNSS coordinate such as Latitude (Lat) and Longitude (Lng). Defining a plurality of waypoints defines the path 520.

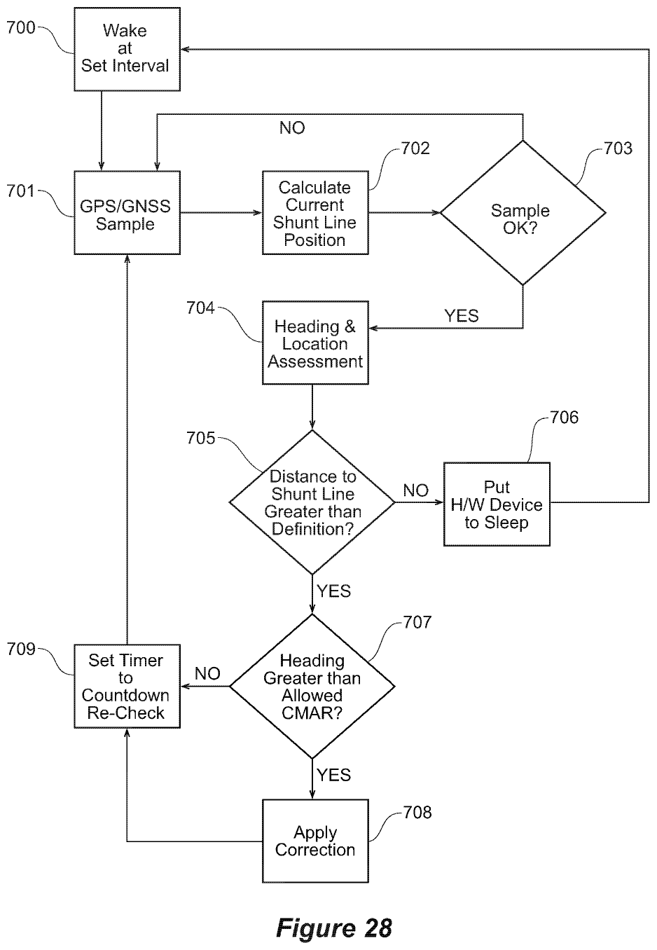

According to an aspect, steering instructions which are converted into stimulus signals, are generated automatically by the microprocessor 820 as it compares the animal's position as measured by the GNSS block 850 using the various methods described previously and as will be described in more detail with reference to FIG. 28 below.

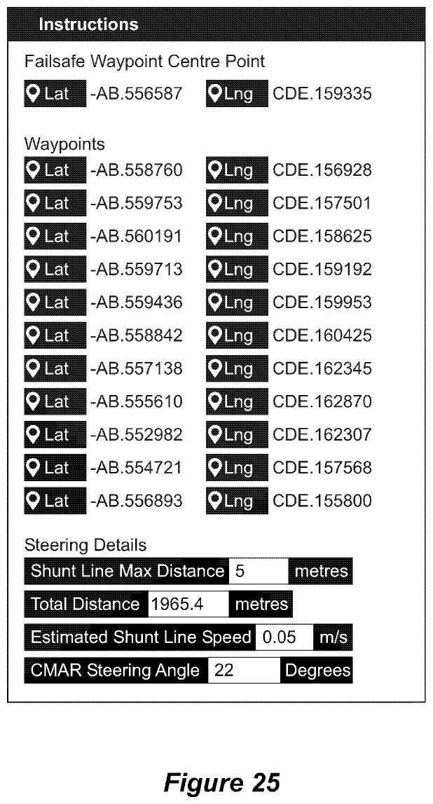

FIG. 25 shows some of the parameters that can be programmed into the device 800 to define a plurality of waypoints to define a path of an area of land such as described previously with reference to FIG. 24. As can be seen in FIG. 25, a Lat and a Lng coordinate are provided for each waypoint defined (in this case 11 waypoints). It will be noted that some of the actual coordinate numbers have been replaced by letters so as to generalise the location.

In some embodiments, a “Failsafe Waypoint” is provided in the event that the animal or herd need to be steered towards a particular point in the event of an emergency such as a detected fire or predator. In this instance, the more strict steering protocols can be used to ensure that the animals go to that point as quickly as possible.

In the example shown in FIG. 25, the Failsafe Waypoint is provided as Lat—AB.556587 and Lng CDE.159335.

The general path-defining waypoints are then entered, each having its own Lat and Lng coordinates. It will be noted from the numbers that each coordinate advances the waypoint to a new but “proximal” location from the last.

A section for defining Steering Details is also provided. These can include in some embodiments, a “Shunt Line Maximum Distance”, which in this example is entered as 5 metres. This parameter equates to the reference distance previously described.

A “Total Distance” value can also be provided, indicating the total distance the path 520 travels. In this example, a value of 1965.4 metres is provided.

An “Estimated Shunt Line Speed” can also be set, to control the speed of movement of the shunt line 300 as previously described with reference to FIGS. 10 to 19. In this example it is set to 0.05 metres/second. A higher value will cause the shunt line 300 to move at a greater speed along the defined path 520.

A “CMAR Steering Angle” can also be set. This angle refers to the allowable heading range previously described with reference to FIGS. 4, 5 and 7, and may be set narrowly or broadly depending upon whether a stricter or looser steering protocol is desired. In this example it is set at 22 degrees.

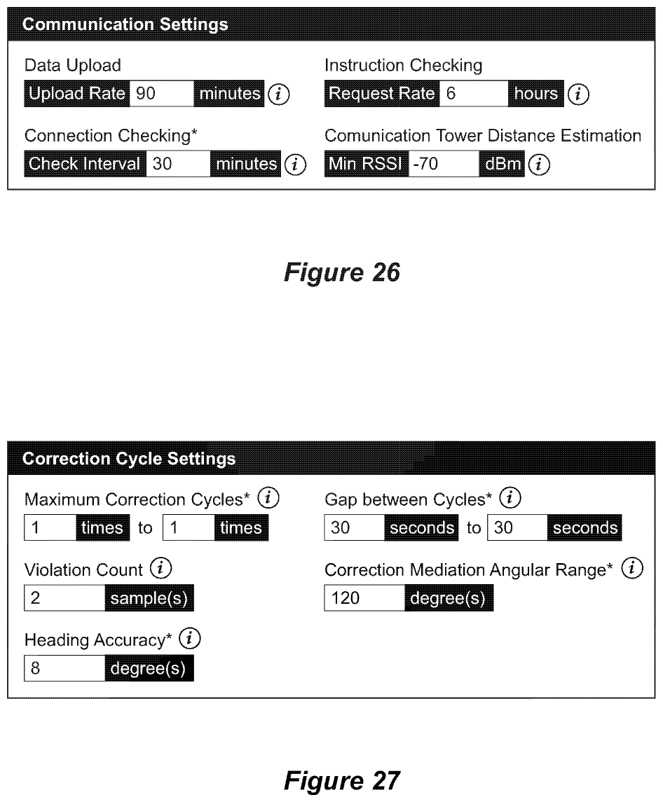

In some embodiments, various Communication Settings may be set, as shown in FIG. 26. The fields shown in this figure are:
Data Upload Rate: This is the maximum interval allowed between telemetry uploads by a single node
Instruction Checking: This is the maximum interval allowed between checking/receiving instructions
Connection Checking: This is the maximum interval allowed between checking for the existence of a Type 2 Base station.
Communications Tower Distance Estimation: This is the lowest signal strength allowed before starting communication to check for instructions.

In some embodiments, various “Correction Cycle Settings” can be set, as shown in FIG. 27. The fields shown in this figure are:
Maximum Correction Cycles: Range of minimum to maximum correction cycles that are allowed which the node determines through a measurement of “compliance”
Violation Count: The number of UPS samples needed before performing a heading & location assessment.
Heading Accuracy: Plus or Minus this value in degrees error allowed to have an acceptable heading value as provided by the GPS unit.
Gap between cycles: The minimum and maximum time to recheck/reassess compliance.
Correction Mediation Angular Range: CMAR is angular range within which an animal's bearing is considered as compliance to a given path (referred to as the “allowable heading”).

It will he appreciated that the views of FIGS. 25 to 27 may be presented as a user interface for a system that may be used to control the various aspects as described. Of course, it will also be appreciated that the information and method of data entry may he provided in many other ways.

FIG. 28 shows an example of a flowchart for the steps of an algorithm for determining an animal's compliance along the set path 520 according to some embodiments using the shunt line 300.

Starting for example, at step 700, the device 800 is caused to move from a “sleep” mode to an “awake” mode at preset intervals. This assists in saving power rather than having the device 800 “awake” at all times. After entering the “Awake” mode at step 700, a position sample is taken at step 701 to determine the animal's location at that particular time. In some embodiments, this data is received from GNSS/GPS block 850 as previously described, and can be provided as a set of Lat and Lng coordinates.

At step 702, the current position of the shunt line 300 is determined using for example, system data defining the speed of the shunt line and the system clock. At step 703, the sample is checked against a number of criteria to ensure that it is a valid sample for use in the calculations. For example, a sample may be deemed to be “OK” if the following conditions are met:
There were at least 3 satellites involved in the calculation (3D fix)
The latitudinal accuracy is within a preset value in metres (hAcc) e.g. 10 metres or less
The longitudinal accuracy is within a preset value in metres (vAcc) e.g. 10 metres or less
The heading accuracy is within the defined heading accuracy for the given instruction set

If the sample is determined to not be OK, then the process moves back to step 701 to obtain a new location sample. If the sample is determined to be OK at step 703, then the method moves on to step 704, to determine the animal's location and heading using the obtained location sample from step 701 to determine location, and in some embodiments, comparing this location to a previous location to determine the animal's heading.

If, at step 705, the animal's distance from the shunt line 300 is determined to be less than the system setting set as previously described with reference to FIG. 25 (i.e. “Shunt Line Maximum Distance”, which in this example is set to 5 metres), then the method moves to step 706 to place the device 800 back into a “Sleep” mode to conserve power, until it is woken again at the next preset interval (for example 10 minutes) at step 700 to repeat the process. The device is able to be placed in a “sleep” mode at this stage because the system has deemed that the animal's location is acceptable with respect to the reference 10 (in embodiments making use of the reference 10) and/or shunt line 300 and that no correction or stimulus is required as previously described.

If however, at step 705, the system determines that the animal's distance from the shunt line 300 is determined to be less than the system setting set as previously described with reference to FIG. 25 (i.e. “Shunt Line Maximum Distance”, which in this example is set to 5 metres), then the method moves to step 707 to determine whether the animal's heading is greater than the allowable heading range (which was previously set in the system settings as previously described with reference to FIG. 25, and set as 22 degrees under the “CMAR Steering Angle” field). If the determination of this step is that the animal's heading is not greater than the allowable heading range, then the method moves on to step 709 to set a countdown to recheck the heading at a later interval (for example 2 minutes). When that countdown is reached, the method moves to step 701 again to repeat the process.

If the determination at step 707 is that the animal's heading is greater than the allowable heading range, then the animal's movement must be corrected and an appropriate stimulus is applied to the animal at step 708. After application of the stimulus at step 708, the method moves on to step 709 to set a countdown to repeat the process to see whether the animal is back on track after application of the stimulus.

It will be appreciated that the steps described above with reference to FIG. 28 are some of many possible variations, and need not be carried out in that order in some embodiments. It will also be appreciated that the steps will differ according to the particular protocol used as previously described. For example, if the steering protocol used is simply the “desired region” method described previously with reference to FIGS. 1A to 1D, or the “reference and reference distance” method described with reference to FIGS. 2A to 3D, then no use will be made of the heading data.

Accordingly there is broadly provided a method of determining whether to apply a stimulus to an animal, the method comprising determining the animal's location; comparing the animal's determined location with one or more system settings; and determining to apply the stimulus to the animal if the animal's location is outside of one or more of the one or more system settings.

In some embodiments, the system settings include distance from a reference and heading.

It will also be appreciated that the steering of the animal may be done in many different ways. For example, in some embodiments, an animal may have two devices, one on each ear. If the device on the animal's left ear is activated (i.e. a stimulus is applied), then this may signal to the animal to turn left. If the device on the animal's right ear is activated, then this may signal to the animal to turn right. In other embodiments, a single device may be used, and the instruction to the animal to turn left or right (or even stop or start) may be coded in a pattern of applied stimulus, such as a haptic stimulus, or a series of electrical stimuli, or a series of audio stimuli. Some methods are very quickly adopted by the animal, and others may require some training.

In a broad aspect then, there is provided a system for controlling the movement of one or more animals by applying one or more stimuli to the one or more animals, the application of the one or more stimuli being determined by any one or more of the methods described herein.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope as claimed.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

In a broad aspect then, there is provided a computer readable medium containing instructions to cause the computer to perform the steps of any one or more of the methods described herein.

Further, it should be appreciated that modules and'or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can he utilized.

In one form there is provided a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The system may be a computer implemented system comprising of a display device, a processor and a memory and an input device. The memory may comprise instructions to cause the processor to execute a method described herein. The processor memory and display device may be included in a standard computing device, such as a desktop computer, a portable computing device such as a laptop computer or tablet, or they may be included in a customised device or system. The computing device may be a unitary computing or programmable device, or a distributed device comprising several components operatively (or functionally) connected via wired or wireless connections.

Any Input/Output Interface used may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). A graphical processing unit (GPU) may also be included. The display apparatus may comprise a flat screen display (eg LCD, LED, plasma, touch screen, etc), a projector, CRT, etc. The computing device may comprise a single CPU (core) or multiple CPU's (multiple core), or multiple processors. The computing device may use a parallel processor, a vector processor, or be a distributed computing device. The memory is operatively coupled to the processors) and may comprise RAM and ROM components, and may be provided within or external to the device. The memory may be used to store the operating system and additional software modules or instructions. The processor(s) may be configured to load and executed the software modules or instructions stored in the memory.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the various aspects described herein are not restricted in their use to the particular application described. Neither are they restricted in their embodiments with regard to the particular elements and/or features described or depicted herein. it will be appreciated that the various aspects are not limited to the embodiment or embodiments disclosed, but is capable of numerous rearrangements, modifications and substitutions without departing from the scope as set forth and defined by the following claims.

1. A method of controlling the movement of an animal, the method comprising:
steering the animal towards a desired region if the animal's location is outside the desired region.

2. A method of controlling the movement of an animal, the method comprising:
steering the animal towards a reference if the animal's location is beyond a reference distance.

3. A method as claimed in claim 2 comprising steering the animal towards a desired region, defined with respect to the reference, if the animal's location is outside of the desired region.

4. A method as claimed in claim 3 comprising not steering the animal if the animal's location is within the desired region.

5. A method as claimed in any one of claims 2 to 4, wherein the reference is moveable.

6. A method as claimed in claim 5 wherein the speed of movement of the reference is adjustable.

7. A method as claimed in any one of claims 2 to 6 further comprising defining the desired region.

8. A method as claimed in claim 7 wherein the step of defining the desired region comprises defining the desired region to be within the reference distance from the reference.

9. A method as claimed in claim 8 wherein the reference distance is adjustable.

10. A method as claimed in any one of claims 7 to 9 wherein the step of defining the desired region comprises defining the desired region to be a region defined by a function with respect to the reference.

11. A method as claimed in claim 10 wherein the function is defined according one or more characteristics of the land about the reference.

12. A method as claimed in any one of claims 2 to 11 wherein the reference is virtual.

13. A method as claimed in any one of claims 2 to 11 wherein the reference is a mobile device.

14. A method as claimed in claim 1 wherein the desired region is caused to move from a start location to a destination location.

15. A method as claimed in any one of claims 2 to 13 wherein the desired region is caused to move from a start location to a destination location by moving the reference from the start location to the destination location.

16. A method of controlling the movement of an animal, the method comprising:
steering the animal towards a desired region if the animal's location is not in the desired region and the animal has a heading that is outside of an allowable heading range.

17. A method as claimed in claim 16 wherein if the animal's location is not in the desired region and the animal's heading is within the allowable heading range, then not steering the animal.

18. A method as claimed in claim 17 wherein the desired region is defined with respect to a reference and the allowable heading range is defined by a heading range in which the reference is located.

19. A method as claimed in any one of claims 1 to 18 wherein the desired region is caused to move from a start location to a destination location.

20. A method of controlling the movement of an animal, the method comprising:
steering the animal out of a steering region if the animal's location is inside the steering region.

21. A method as claimed in claim 20 wherein if the animal's position is inside a desired region or outside of the desired region but not inside the steering region, then not steering the animal.

22. A method as claimed in any one of claim 20 or 21 wherein the steering region and/or the desired region are defined with respect to a reference.

23. A method of controlling the movement of an animal from a start location to a destination location, the method comprising:
if the animal's position is within a steering region, then steering the animal out of the steering region towards a desired region defined by a shunt line having the desired region on a side of the shunt line incorporating the destination location and the steering region on the other side of the shunt line.

24. A method as claimed in claim 23 further comprising:
causing the shunt line to move towards the destination location.

25. A method as claimed in claim 24 further comprising defining a path between the start location and the destination location, and causing the shunt line to move along the defined path.

26. A method as claimed in claim 25 comprising setting at least one waypoint WPi along the path between the start location and the destination location, and causing the shunt line to move from the start location to the at least one waypoint WPi.

27. A method as claimed in claim 26 wherein the at least one waypoint WPi is set according to one or more characteristics of the land through which the path passes.

28. A method as claimed in claim 27 comprising orientating the shunt line to be substantially perpendicular to a direct line joining the shunt line to a next waypoint WPi+1.

29. A method as claimed in claim 28 comprising:
assigning a deviation angle θdev defined by the acute angle at the waypoint WPi between the line joining the waypoint WPi and a waypoint WPi+1 and the line joining waypoint Wi and a waypoint WPi+2;
determining an instantaneous angle θinst defined by the acute angle at the shunt line between the line joining the waypoint WPi and a waypoint WPi+1 and the line joining waypoint Wi and a waypoint WPi+2; and
if the instantaneous angle θinst is greater than the deviation angle θdev then rotating the shunt line so that it is substantially perpendicular to a line joining the shunt line at the path and the waypoint WPi+2.

30. A method as claimed in any one of claims 23 to 29 wherein the desired region is defined as a region within a locus of a parabola defined with respect to the reference and the shunt line is an asymptote of the parabola at the vertex.

31. A method as claimed in claim 30 wherein the parabola is defined with respect to the reference as the parabola's focal point.

32. A method as claimed in claim 30 wherein the parabola is defined with respect to the reference as the parabola's vertex.

33. A method as claimed in any one of claims 23 to 32 wherein the desired region is defined as a region within a spline locus of a parabola defined with respect to the reference.

34. A method as claimed in claim 33 wherein the spline locus is calculated based on system settings.

35. A method as claimed in any one of claims 33 to 34 wherein the width of the spline locus is defined by setting a locus angle of displacement relative to the asymptote.

36. A method as claimed in any one of claims 33 to 35 wherein the width of the spline locus is defined according to geography and/or topology of land about the spline locus.

37. A method of defining a path between a start location to a destination location, the method comprising:
defining one or more waypoints between the start location and the destination location.

38. A method as claimed in claim 37 wherein the step of defining the one or more waypoints comprises defining a Latitude and a Longitude coordinate for each of the one or more waypoints.

39. A method as claimed in claim 37 wherein one or more attributes are assigned to one or more of the one or more waypoints.

40. A method as claimed in claim 39 wherein the one or more attributes include instructions to orientate a shunt line, instructions to change a width of a desired region, instructions to pause progress of the desired region along the path, and instructions to speed or slow the rate of speed of a desired region travelling along the path.

41. A method of determining whether to apply a stimulus to an animal, the method comprising:
determining the animal's location;
comparing the animal's determined location with one or more system settings; and
determining to apply the stimulus to the animal if the animal's location is outside of one or more of the one or more system settings.

42. A method as claimed in claim 41 wherein the one or more system settings including distance from a reference and heading.

43. A system for controlling the movement of one or more animals by applying one or more stimuli to the one or more animals, the application of the one or more stimuli being determined by the method of any one or more of claims 1 to 42.

44. A device for applying a stimulus to an animal in accordance with the method of any one or more of claims 1 to 42.

45. A computer readable medium containing instructions to cause the computer to perform the steps of the method of any one or more of claims 1 to 42.
